(19) United States
(12) Patent Application Publication
(10) Pub. No.: US 2004/0034726 A1
(43) Pub. Date: Feb. 19, 2004

(54) Changeable wireless functional device

(75) Inventors: Shih Chieh Cheng, Hsinchu (TW); Sidney Young, Hsinchu (TW); Jui Chung Chen, Kaohsiung Hsien (TW)

Correspondence Address: BACON & THOMAS, PLLC, 625 SLATERS LANE, FOURTH FLOOR, ALEXANDRIA, VA, 22314

(73) Assignees: C-One Technology Corporation, Hsin-Chu City (TW); Pretec Electronics Corporation, Fremont, CA

(21) Appl. No.: 10/357,365

(22) Filed: Feb. 4, 2003

(30) Foreign Application Priority Data
Aug. 14, 2002 (TW) 91212620

(51) Int. Cl. G06F 13/12

(52) U.S. Cl. 710/62

(57) ABSTRACT

A changeable wireless functional device has a microprocessor and an insertable interface having a card detection pin. When detecting that the insertable interface is inserted with an UART/CF module, the microprocessor executes a program supporting the functions of accessory equipment, thereby making the changeable wireless functional device become a wireless electronic card. When detecting that the insertable interface is inserted with a keyboard and display module, the microprocessor executes a program supporting the functions of mobile device, thereby making the changeable wireless functional device become a mobile phone handset.

### BACKGROUND OF THE INVENTION

1. Field of the Invention

The present invention relates to a changeable wireless functional device, and more particularly to a changeable wireless functional device which can change its function to match the different requirements.

2. Description of the Related Art

Various wireless electronic products with compact sizes are developed and manufactured to match the requirements of a varitey of customers, for example, mobile phone handset, wireless electronic card attached to the Personal Digital Assistant (PDA), or PDA with wireless functional devices. These wireless products mainly provide speech communication and data communication. For example, a handset serves for executing speech communcation, and a PDA with a wireless electronic card serves to surf to a network or receiving E-mails and other data communication.

The above wireless comunication products have similar wiless transmitting and receiving functions. However, since they have different uses and objects, different products are developed and the user has to equip different products for having the above similar wireless receiving and transmitting functions. Thereby, not only the product developing processes are overlapped, but also the cost for buying these products are increased.

### SUMMARY OF THE INVENTION

Accordingly, the object of the present invention is to provide a changeable wireless functional device for developing different wireless functional devices by the same platform. Thereby, the cost in development and time for research can be reduced. Moreover, the present invention provides a modulalized design so that the wireless electronic products can response the market demand rapidly and conveniently.

To achieve above object, the changeable wireless functional device in accordance with the present invention includes at least one insertable interface for being selectively insetrted with a standard interface module and an I/O module, the insertable interface having at least one card detection pin for detecting whether the insertable interface is inserted with the standard interface module or the I/O module; a microprocessor coupled to the insertable interface for detecting status of the card detection pin so as to selectively execute a first firmware and a second firmware corresponding to the standard interface module and the I/O module, respectively; and a digital signal processing and RF module coupled to the microprocessor and controlled by the microprocessor for executing functions of wireless receiving and transmitting and signal processing.

The various objects and advantages of the present invention will be more readily understood from the following detailed description when read in conjunction with the appended drawing.

### BRIEF DESCRIPTION OF THE DRAWINGS

FIG. 1 shows one preferred embodiment of the changeable wireless functional device of the present invention.

FIG. 2 is a schematic view showing that the changeable wireless functional device of the present invention is set as a wireless electronic card.

FIG. 3 is a schematic view showing that the changeable wireless functional device of the present invention is set as a mobile phonehandset.

FIG. 4 shows another preferred embodiment of the changeable wireless functional device of the present invention.

### DETAILED DESCRIPTION OF THE PREFERRED EMBODIMENTS

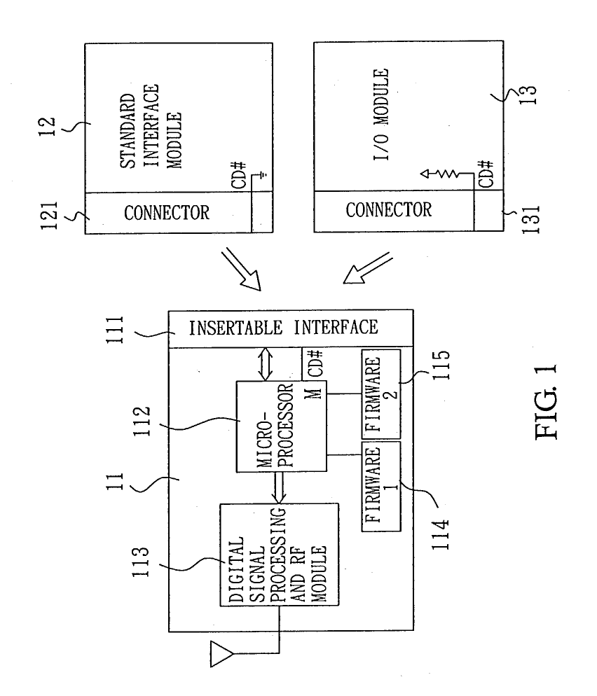

Referring to FIG. 1, a prefered embodiment of the changeable wireless functional device of the present invention is illustrated. The present invention mainly includes an insertable interface 111, a microprocessor 112, and a digital signal processing and RF module 113. The insertable interface 111 can be inserted by a standard interface module 12 or an I/O module 13. The microprocessor 112 is coupled to the insertable interface 111. The digital signal processing and RF module 113 is coupled to the microprocessor 112 so as to perform wireless receiving and signal processing processes under the control of the microprocessor 112.

In the insertable interface 111, a card detection pin CD# is provided, which is connected to the mode setting pin M of the microprocessor 112, for detecting whether the insertable interface 111 is inserted with the standard interface module 12 or the I/O module 13. As shown, the standard interface module 12 has a connector 121 corresponding to the insertable interface 111. The potential of the connector 121 corresponding to the card detection pin CD# is grounded, and the I/O module 13 also has a connector 131 corresponding to the insertable interface 111. The potential of the connector 131 corresponding to the card detection pin CD# is the system high level. Therefore, when the standard interface module 12 is inserted into the insertable interface 111, the potential of the card detection pin CD# is grounded. On the contrary, when the I/O module 13 is inserted into the insertable interface 111, the potential of the card detection pin CD# is system high level.

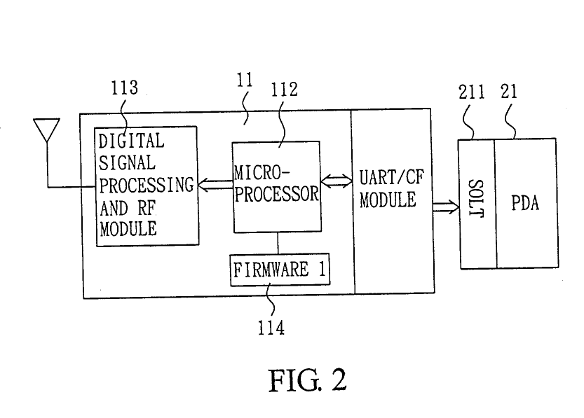

Therefore, when the standard interface module 12 is inserted into the insertable interface 111, the mode setting pin M of the microprocessor 112 is at lower level, and the microprocessor 112 executes a first firmware 114. When the I/O module 13 is iserted into the insertable interface 111, the mode setting pin M of the microprocessor 112 changes into high level, and the microprocessor 112 executes a second firmware 115. In this preferred embodiment, the standard interface module 12 is an UART/CF module for providing an UART/CF standard interface to be connected to a computer device, such as a PDA. The first firmware 114 is a program supporting the function of accessory equipment. With reference to FIG. 2, when the microprocessor 112 executes the first firmware 114, the changeable wireless functional module 11 inserted with the UART/CF module is a wireless electronic card, which can be inserted into a UART/CF slot 211 of a PDA 21 via the UART/CF module, thereby enabling the PDA 21 to execute wireless data transmission.

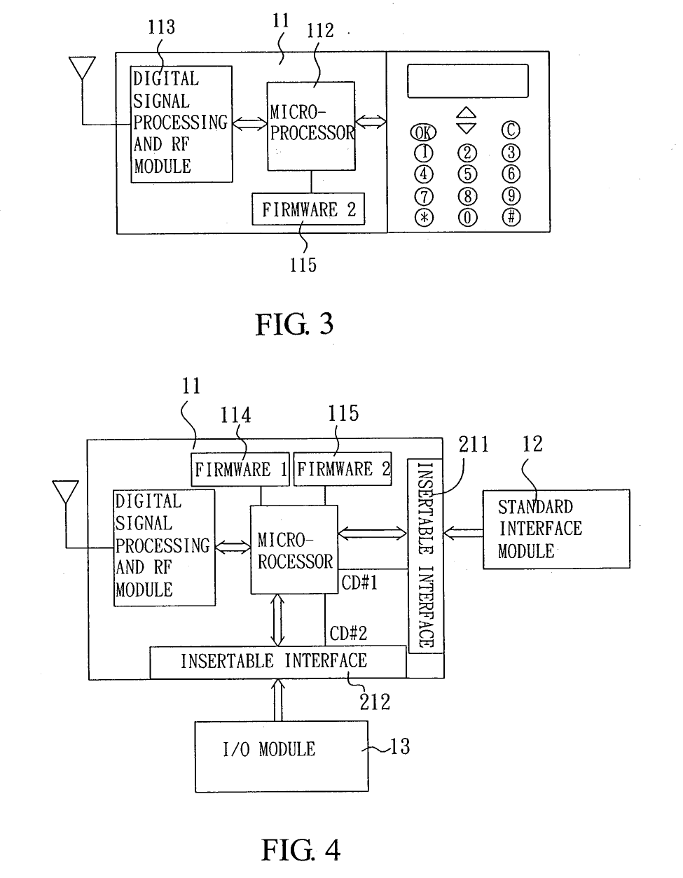

Moreover, in this preferred embodiment, the I/O module 13 is a keyboard and display module for providing I/O functions such as keyborad input and LCD display. The second firmware 115 is a program supporting the function of mobile device. Therefore, referring to FIG. 3, when the microprocessor 112 executes the second firmware 115, the changeable wireless functional module 11 inserted with the keyboard and display module is a handset for performing wireless speech communication.

Another preferred embodiment of the changeable wireless functional module 11 according to the present invention is illustrated in FIG. 4. This embodiment is similar to the previous one except that two insertable interfaces 211 and 212 are employed. Thsee two insertable interfaces 211 and 212 are provided to be inserted with the standard interface module 12 and the I/O module 13, resepctively. By simply detecting the card detection pin CD#1 and card detection pin CD#2 of the two insertable interfaces 211 and 212, respectively, the microprocessor 112 is able to determine whether that inserted into the changeable wireless functional module 11 is a standard interface module 12 or an I/O module 13, so as to switch to execute the corresponding first firmware 114 or second firmware 115. As a result, the changeable wireless functional module 11 becomes a wireless electronic card or a mobile phone handset.

In view of the foregoing, it is known that the changeable wireless functional module 11 of the present invention can be used to develop wireless functional devices, for example wireless electronic cards and handsets, by the same platform. Thereby, the cost in development and time for research can be reduced. Moreover, the present invention provide a modulalized design so that the wireless electronic products can response the market demand rapidly and conveniently.

Although the present invention has been explained in relation to its preferred embodiment, it is to be understood that many other possible modifications and variations can be made without departing from the spirit and scope of the invention as hereinafter claimed.

What is claimed is:

1. A changeable wireless functional device comprising:
at least one insertable interface for being selectively insetrted with a standard interface module and an I/O module, the insertable interface having at least one card detection pin for detecting whether the insertable interface is inserted with the standard interface module or the I/O module;
a microprocessor coupled to the insertable interface for detecting status of the card detection pin so as to selectively execute a first firmware and a second firmware corresponding to the standard interface module and the I/O module, respectively; and
a digital signal processing and RF module coupled to the microprocessor and controlled by the microprocessor for executing functions of wireless receiving and transmitting and signal processing.

2. The changeable wireless functional device as claimed in claim 1, wherein the first firmware is a program supporting functions of accessory equipment.

3. The changeable wireless functional device as claimed in claim 2, wherein. the standard interface module is an UART/CF module.

4. The changeable wireless functional device as claimed in claim 3, wherein the standard interface module has a connector corresponding to the insertable interface and a potential of the connector corresponding to the card detection pin is grounded.

5. The changeable wireless functional device as claimed in claim 1, wherein the second firmware is a program supporting functions of mobile devices.

6. The changeable wireless functional device as claimed in claim 5, wherein the I/O module is a keyborad and display module.

7. The changeable wireless functional device as claimed in claim 6, wherein the I/O module has a connector corresponding to the insertable interface, and a potential of the connector of the I/O module corresponding to the card detection pin is a system high level.
